(19) United States
(12) Patent Application Publication
(10) Pub. No.: US 2021/0214269 A1
(43) Pub. Date: Jul. 15, 2021

(54) TEMPERED GLASS AND GLASS FOR TEMPERING

(71) Applicant: Nippon Electric Glass Co., Ltd., Shiga (JP)

(72) Inventor: Ken YUKI, Shiga (JP)

(21) Appl. No.: 17/059,582

(22) PCT Filed: May 30, 2019
(86) PCT No.: PCT/JP2019/021544

§ 371 Date: Nov. 30, 2020

(30) Foreign Application Priority Data
Jun. 1, 2018 (JP) 2018-105958

(51) Int. Cl. C03C 3/097; C03C 3/095; C03C 3/091; C03C 4/18; C03C 10/00; C03C 21/00

(52) U.S. Cl. CPC C03C 3/097; C03C 3/095; C03C 3/091; C03C 2204/00; C03C 10/0009; C03C 10/0054; C03C 21/002; C03C 4/18

(57) ABSTRACT

The present invention provides a tempered glass including, in a surface thereof, a compressive stress layer obtained through ion exchange, wherein the tempered glass includes as a composition, in terms of mol %, 50% to 80% of SiO₂, 0% to 20% of Al₂O₃, 0% to 10% of B₂O₃, 0% to 15% of P₂O₅, 0% to 35% of Li₂O, 0% to 12% of Na₂O, and 0% to 7% of K₂O.

### TECHNICAL FIELD

The present invention relates to a tempered glass, and more particularly, to a tempered glass suitable as a cover glass for a touch panel display of, for example, a cellular phone, a digital camera, or a personal digital assistant (PDA).

### BACKGROUND ART

A cellular phone, a digital camera, a personal digital assistant (PDA), or the like shows a tendency of further prevalence. In those applications, a cover glass is used for protecting a touch panel display (see Patent Literature 1).

### CITATION LIST

### Patent Literature

Patent Literature 1: JP 2006-083045 A

### SUMMARY OF INVENTION

### Technical Problem

The cover glass, particularly a cover glass used for a smartphone is often used on the move, and hence is liable to be broken when dropped onto a road surface. Therefore, in the applications as the cover glass, it is important to improve scratch resistance against dropping onto a road surface.

As a method of improving the scratch resistance, there is known a method involving using a tempered glass having, in a surface thereof, a compressive stress layer obtained through ion exchange. In particular, an increase in depth of layer of the compressive stress layer is effective in improving the scratch resistance.

However, when the depth of layer is to be increased, there is a risk in that an internal tensile stress is excessively increased, and the glass is shattered into pieces at the time of breakage to pose a danger to a human body. Therefore, there has been a limit in increasing the depth of layer.

The present invention has been made in view of the above-mentioned circumstances, and a technical object of the present invention is to devise a tempered glass which is not shuttered into pieces at the time of breakage even when its depth of layer is increased.

### Solution to Problem

The inventor of the present invention has made various investigations, and as a result, has found that the above-mentioned technical object can be achieved when a critical energy release rate Gc before ion exchange is increased to a predetermined value or more by strictly restricting a glass composition. Thus, the finding is proposed as the present invention. That is, according to one embodiment of the present invention, there is provided a tempered glass, comprising, in a surface thereof, a compressive stress layer obtained through ion exchange, wherein the tempered glass comprises as a composition, in terms of mol o, 50% to 80% of SiO₂, 0% to 20% of Al₂O₃, 0% to 10% of B₂O₃, 0% to 15% of P₂O₅, 0% to 35% of Li₂O, 0% to 12% of Na₂O, and 0% to 7% of K₂O.

In addition, it is preferred that the tempered glass according to the one embodiment of the present invention have a critical energy release rate Gc of 8.0 J/m² or more before the ion exchange. With this, energy required for being shattered into pieces is increased, and hence the number of broken pieces at the time of breakage is easily reduced. In addition, a CT limit is easily reduced. As a result, the tempered glass which is not shuttered into pieces at the time of breakage even when its depth of layer is increased can be obtained. The “critical energy release rate Gc” as used herein refers to a value calculated by the equation: Gc=K_{lc}²/E. In this equation, the “K_{lc}” refers to fracture toughness (MPa·m^{0.5}), and the “E” refers to a Young's modulus (GPa). The “fracture toughness K_{1C}” is measured by a Single-Edge-Precracked-Beam method (SEPB method) based on “Testing methods for fracture toughness of fine ceramics at room temperature” of JIS R1607. The SEPB method is a method involving measuring, by a three-point bending fracture test of a precracked specimen, a maximum load when the specimen is fractured, and determining a plane-strain fracture toughness K_{1C} based on the maximum load, the length of the crack, the dimensions of the specimen, and a distance between bending fulcrums. The measured value for the fracture toughness K_{1c} of each glass is an average value over five times of measurement. The “Young's modulus” may be measured by a well-known resonance method.

In addition, it is preferred that the tempered glass according to the one embodiment of the present invention have a Young's modulus of 80 GPa or more.

In addition, it is preferred that the tempered glass according to the one embodiment of the present invention be formed of crystallized glass, and it is preferred that the crystallized glass have a crystallinity of 5% or more. In addition, it is preferred that, in the tempered glass according to the one embodiment of the present invention, the crystallized glass have a crystallite size of 500 nm or less. Further, it is preferred that, in the tempered glass according to the one embodiment of the present invention, the crystallized glass comprise lithium disilicate as a main crystal. The “crystallinity” as used herein may be evaluated by a powder method with an X-ray diffractometer (RINT-2100 manufactured by Rigaku Corporation). Specifically, a halo area corresponding to a mass of an amorphous component and a peak area corresponding to a mass of a crystalline component are calculated, and then the crystallinity may be determined by the expression: [peak area]×100/[peak area+halo area] (%). The “crystallite size” may be calculated by a Scherrer equation from the analysis results of the powder X-ray diffraction. The “main crystal” may be identified from the analysis results of the powder X-ray diffraction.

In addition, it is preferred that the tempered glass according to the one embodiment of the present invention have a sheet shape and have a thickness of from 0.1 mm to 2.0 mm.

In addition, it is preferred that, in the tempered glass according to the one embodiment of the present invention, the compressive stress layer have a compressive stress value of 300 MPa or more and a depth of layer of 15 μm or more. The “compressive stress value” and the “depth of layer” as used herein refer to values calculated with a surface stress meter (FSM-6000LE manufactured by Orihara industrial co., ltd.).

In addition, it is preferred that the tempered glass according to the one embodiment of the present invention have a CT limit of more than 65 MPa. The “CT limit” as used herein refers to an internal tensile stress value at which the number of broken pieces each having a size of 0.2 mm or more is 100 pieces/in². The “internal tensile stress value at which the number of broken pieces is 100 pieces/in²” is calculated as described below. First, an indenter test using a diamond tip is performed on a surface plate. When a delayed fracture occurs, data on the number of broken pieces at a CTcv value (two points) at which the number of broken pieces exceeds 100 pieces/in², and data on the number of broken pieces at a CTcv value (two points) at which the number of broken pieces is less than 100 pieces/in² are collected. Next, an exponential approximation curve is drawn from the data on the number of broken pieces at the CTcv values at the total four points, and then the CT limit is calculated from the approximation curve as a CTcv value at which the number of broken pieces is 100. The CTcv value may be obtained with software FsmV of surface stress meter FSM-6000LE manufactured by Orihara industrial co., ltd. In addition, the data on the number of broken pieces at each point is an average value over three times of measurement.

In addition, it is preferred that the tempered glass according to the one embodiment of the present invention be used as a cover glass for a touch panel display.

According to one embodiment of the present invention, there is provided a glass to be tempered for producing a tempered glass comprising, in a surface thereof, a compressive stress layer obtained through ion exchange, the glass to be tempered comprising as a composition, in terms of mol %, 50% to 80% of SiO₂, 0% to 20% of Al₂O₃, 0% to 10% of B₂O₃, 0% to 15% of P₂O₅, 0% to 35% of Li₂O, 0% to 12% of Na₂O, and 0% to 7% of K₂O.

In addition, it is preferred that the glass to be tempered according to the one embodiment of the present invention have a critical energy release rate Gc of 8.0 J/m² or more.

In addition, it is preferred that the glass to be tempered according to the one embodiment of the present invention be formed of crystallized glass.

### DESCRIPTION OF EMBODIMENTS

A tempered glass of the present invention comprises as a composition, in terms of mol %, 50% to 80% of SiO₂, 0% to 20% of Al₂O₃, 0% to 10% of B₂O₃, 0% to 15% of P₂O₃, 0% to 35% of Li₂O, 0% to 12% of Na₂O, and 0% to 7% of K₂O. The reasons why the contents of the components are limited as described above are described below. In the description of the content of each component, the expression “%” represents “mol %” unless otherwise specified.

SiO₂ is a component that forms a glass network, and is also a component for precipitating a crystal, such as lithium disilicate. The content of SiO₂ is preferably from 50% to 80%, from 55% to 75%, or from 60% to 73%, particularly preferably from 65% to 70%. When the content of SiO₂ is too small, vitrification does not occur easily, and a Young's modulus and weather resistance are liable to be reduced. Meanwhile, when the content of SiO₂ is too large, meltability and formability are liable to be reduced. In addition, a thermal expansion coefficient becomes too low, with the result that it becomes difficult to match the thermal expansion coefficient with those of peripheral materials.

Al₂O₃ is a component that increases a critical energy release rate Gc and ion exchange performance. However, when the content of Al₂O₃ is too large, a viscosity at high temperature is increased, and the meltability and the formability are liable to be reduced. In addition, a devitrified crystal is liable to be precipitated in the glass, and it becomes difficult to form the glass into a sheet shape by an overflow down-draw method or the like. Therefore, the upper limit of the content range of Al₂O₃ is preferably 20% or less, 19.5% or less, 19% or less, 18.8% or less, 18.7% or less, 18.6% or less, 18.5% or less, 18% or less, 15% or less, 12% or less, 10% or less, or 6% or less, particularly preferably 5% or less. In addition, the lower limit thereof is preferably 0% or more, 0.1% or more, 0.5% or more, 1% or more, or 2% or more, particularly preferably 4% or more, and when an emphasis is placed on the ion exchange performance, is 12% or more, more than 15%, 15.5% or more, or 17% or more, particularly 18% or more.

B₂O₃ is a component that improves the meltability and devitrification resistance. However, when the content of B₂O₃ is too large, the critical energy release rate Gc and the weather resistance are liable to be reduced. Therefore, the content of B₂O₃ is preferably from 0% to 10%, from 0% to 7%, from 0% to 5%, or from 0% to 3%, particularly preferably from 0% to less than 1%.

P₂O₅ is a component for forming a crystal nucleus. However, when P₂O₅ is introduced in a large amount, the glass is liable to undergo phase separation. Therefore, the content of P₂O₅ is preferably from 0% to 15%, from 0.1% to 10%, from 0.1% to 5%, or from 0.4% to 4.5%, particularly preferably from 0.5% to 3%.

Li₂O is a component for precipitating a crystal, such as lithium disilicate, and further, is a component that increases the critical energy release rate Gc and the ion exchange performance. However, when the content of Li₂O is too large, the weather resistance is liable to be reduced. Therefore, the upper limit of the content range of Li₂O is preferably 35% or less, 32% or less, 30% or less, 29% or less, 28% or less, 26% or less, 25% or less, or 23% or less, particularly preferably 22% or less, and when an emphasis is placed on the weather resistance, is 15% or less, 12% or less, 10% or less, 9.8% or less, 9.5% or less, 9.4% or less, 9.3% or less, 9% or less, 8.5% or less, 8.3% or less, or 8% or less, particularly 7.8% or less. In addition, the lower limit thereof is preferably 0% or more, 1% or more, 2% or more, 3% or more, 4% or more, 4.5% or more, 5% or more, 5.5% or more, 6% or more, 6.3% or more, or 6.5% or more, particularly preferably 6.6% or more.

Na₂O is a component that improves the ion exchange performance, and is also a component that reduces the viscosity at high temperature to remarkably improve the meltability. In addition, Na₂O is a component that contributes to initial melting of glass raw materials. However, when the content of Na₂O is too large, a crystallite size is liable to be coarsened, and the weather resistance is liable to be reduced. Therefore, the upper limit of the content range of Na₂O is preferably 12% or less, 10% or less, 9.8% or less, 9.5% or less, 9.3% or less, 9.1% or less, 9% or less, or 8.7% or less, particularly preferably 7% or less, and when an emphasis is placed on the weather resistance, is 6% or less, 5% or less, 4% or less, 3% or less, 2% or less, or 1% or less, particularly less than 1%. In addition, the lower limit thereof is preferably 0% or more, 0.1% or more, 0.5% or more, 1% or more, 3% or more, 4% or more, 5% or more, 5.5% or more, 6% or more, or 6.5% or more, particularly preferably 7% or more.

K₂O is a component that improves the ion exchange performance, and is also a component that reduces the viscosity at high temperature to improve the meltability. However, when the content of K₂O is too large, the crystallite size is liable to be coarsened. Therefore, the content of K₂O is preferably from 0% to 7%, from 0% to 5%, or from 0% to 3%, particularly preferably from 0% to less than 1%.

Any other component than the above-mentioned components may be introduced as an optional component.

MgO is a component that increases the Young's modulus and the ion exchange performance, and reduces the viscosity at high temperature to improve the meltability. However, when the content of MgO is too large, the glass is liable to be devitrified at the time of forming. Therefore, the content of MgO is preferably from 0% to 10%, from 0% to 7%, or from 0% to 4%, particularly preferably from 0% to 2%.

CaO is a component that reduces the viscosity at high temperature to improve the meltability. In addition, among alkaline earth metal oxides, CaO is a component that reduces a batch cost because a raw material for introducing CaO is relatively inexpensive. However, when the content of CaO is too large, the glass is liable to be devitrified at the time of forming. Therefore, the content of CaO is preferably from 0% to 5%, from 0% to 3%, or from 0% to 1%, particularly preferably from 0% to 0.5%.

SrO is a component that suppresses phase separation, and is also a component that suppresses the coarsening of the crystallite size. However, when the content of SrO is too large, it becomes difficult to precipitate a crystal through heat treatment. Therefore, the content of SrO is preferably from 0% to 5%, from 0% to 4%, or from 0% to 3%, particularly preferably from 0% to 2%.

BaO is a component that suppresses the coarsening of the crystallite size. However, when the content of BaO is too large, it becomes difficult to precipitate a crystal through heat treatment. Therefore, the content of BaO is preferably from 0% to 5%, from 0% to 4%, or from 0% to 3%, particularly preferably from 0% to 2%.

ZnO is a component that reduces the viscosity at high temperature to remarkably improve the meltability, and is also a component that suppresses the coarsening of the crystallite size. However, when the content of ZnO is too large, the glass is liable to be devitrified at the time of forming. Therefore, the content of ZnO is preferably from 0% to 5%, from 0% to 3%, or from 0% to 2%, particularly preferably from 0% to 1%.

ZrO₂ is a component that increases the critical energy release rate Gc and the weather resistance, and is also a component for forming the crystal nucleus. However, when ZrO₂ is introduced in a large amount, the glass is liable to be devitrified. In addition, a raw material for introducing ZrO₂ has low solubility, and hence there is a risk in that undissolved foreign matter is mixed in the glass. Therefore, the content of ZrO₂ is preferably from 0% to 10%, from 0.1% to 9%, from 1% to 7%, or from 2% to 6%, particularly preferably from 3% to 5%.

TiO₂ is a component for forming the crystal nucleus, and is also a component that improves the weather resistance. However, when TiO₂ is introduced in a large amount, the glass is colored, and a transmittance is liable to be reduced. Therefore, the content of TiO₂ is preferably from 0% to 5% or from 0% to 3%, particularly preferably from 0% to less than 1%.

SnO₂ is a component that improves the ion exchange performance. However, when the content of SnO₂ is too large, the devitrification resistance is liable to be reduced. Therefore, the content of SnO₂ is preferably from 0% to 3%, from 0.01% to 3%, from 0.05% to 3%, or from 0.1% to 3%, particularly preferably from 0.2% to 3%.

As a fining agent, one kind or two or more kinds selected from the group consisting of Cl, SO₃, and CeO₂ (preferably the group consisting of Cl and SO₃) may be added at from 0.001% to 1%. In addition, as the fining agent, Sb₂O₃ may be added at from 0.001% to 1%. An effective fining agent may be added depending on the viscosity at high temperature varied with a composition.

A suitable content of Fe₂O₃ is less than 1,000 ppm (less than 0.1%), less than 800 ppm, less than 600 ppm, or less than 400 ppm, particularly less than 300 ppm. Further, a molar ratio SnO₂/(Fe₂O₃+SnO₂) is controlled to preferably 0.8 or more or 0.9 or more, particularly preferably 0.95 or more, while the content of Fe₂O₃ is controlled in the above-mentioned ranges. With this, a total light transmittance at a wavelength of from 400 nm to 770 nm with a thickness of 1 mm is easily improved.

Y₂O₃ is a component that increases the critical energy release rate Gc. However, a raw material of Y₂O₃ itself has a high cost. In addition, when Y₂O₃ is added in a large amount, the devitrification resistance is liable to be reduced. Therefore, the content of Y₂O₃ is preferably from 0% to 15%, from 0.1% to 12%, from 1% to 10%, or from 1.5% to 8%, particularly preferably from 2% to 6%.

Gd₂O₃, Nb₂O₅, La₂O₃, Ta₂O₅, and HfO₂ are each a component that increases the critical energy release rate Gc. However, the costs of raw materials of Gd₂O₃, Nb₂O₅, La₂O₃, Ta₂O₅, and HfO₂ are high in themselves. In addition, when Gd₂O₃, Nb₂O₅, La₂O₃, Ta₂O₅, and HfO₂ are added in large amounts, the devitrification resistance is liable to be reduced. The total content and the individual contents of Gd₂O₃, Nb₂O₅, La₂O₃, Ta₂O₅, and HfO₂ are each preferably from 0% to 15%, from 0% to 10%, or from 0% to 5%, particularly preferably from 0% to 3%.

It is preferred that the tempered glass of the present invention be substantially free of As₂O₃, PbO, F, and the like as a composition from the standpoint of environmental considerations. In addition, it is also preferred that the tempered glass be substantially free of Bi₂O₃ from the standpoint of environmental considerations. The “substantially free of” has a concept in which the explicit component is not positively added as a glass component, but its addition at an impurity level is permitted, and specifically refers to the case in which the content of the explicit component is less than 0.05%.

Before ion exchange, the tempered glass of the present invention has a critical energy release rate Gc of preferably 5.0 J/m² or more, 5.5 J/m² or more, 5.8 J/m² or more, 6.0 J/m² or more, 6.2 J/m² or more, 6.4 J/m² or more, 6.5 J/m² or more, 6.6 J/m² or more, 6.8 J/m² or more, 7.0 J/m² or more, 7.2 J/m² or more, 7.4 J/m² or more, 7.6 J/m² or more, 7.8 J/m² or more, 8.0 J/m² or more, 12 J/m² or more, 15 J/m² or more, 20 J/m² or more, or 25 J/m² or more, particularly preferably from 30 J/m² to 50 J/m² or more. When the critical energy release rate Gc is too small, energy required for being shattered into pieces is reduced, and hence the number of broken pieces at the time of breakage is liable to be increased. In addition, a CT limit is liable to be reduced.

The tempered glass of the present invention is preferably formed of crystallized glass so that the critical energy release rate Gc is increased. A main crystal type of the crystallized glass is not particularly limited, but is preferably any one of lithium metasilicate, lithium disilicate, enstatite, β-quartz, β-spodumene, nepheline, carnegieite, lithium aluminosilicate, cristobalite, mullite, and spinel, and is particularly preferably lithium disilicate. When the main crystal is a crystal other than the above-mentioned crystals, the critical energy release rate Gc is liable to be reduced.

When the tempered glass is formed of the crystallized glass, its crystallinity is preferably 10% or more or 20% or more, particularly preferably from 30% to 90%. When the crystallinity is too low, the critical energy release rate Gc is liable to be reduced. Meanwhile, when the crystallinity is too high, an ion exchange rate is reduced, and manufacturing efficiency of the tempered glass is liable to be reduced.

The crystallite size is preferably 500 nm or less, 300 nm or less, 200 nm or less, or 150 nm or less, particularly preferably 100 nm or less. When the crystallite size is too large, the mechanical strength of the tempered glass is liable to be reduced. In addition, a crystal is escaped, for example, at the time of end-surface processing, and the surface roughness of the tempered glass is liable to be reduced. Further, transparency is liable to be reduced.

The tempered glass of the present invention preferably has the following characteristics.

A density is preferably 3.50 g/cm³ or less, 3.25 g/cm³ or less, 3.00 g/cm³ or less, 2.90 g/cm³ or less, 2.80 g/cm³ or less, 2.70 g/cm³ or less, or 2.60 g/cm³ or less, particularly preferably from 2.37 g/cm³ to 2.55 g/cm³. As the density becomes smaller, the weight of the tempered glass can be reduced more. The density is easily reduced by increasing the contents of SiO₂, B₂O₃, and P₂O₅ or reducing the contents of the alkali metal oxides, the alkaline earth metal oxides, ZnO, ZrO₂, and TiO₂ in the glass composition.

A thermal expansion coefficient within the temperature range of from 30° C. to 380° C. is preferably 150×10⁻⁷/° C. or less or 130×10⁻⁷/° C. or less, particularly preferably from 50×10⁻⁷/° C. to 120×10⁻⁷/° C. When the thermal expansion coefficient within the temperature range of from 30° C. to 380° C. is outside the above-mentioned ranges, it becomes difficult to match the thermal expansion coefficient with those of various films, and a defect, such as film peeling, is liable to occur. The “thermal expansion coefficient within the temperature range of from 30° C. to 380° C.” as used herein refers to a value measured with a dilatometer.

A crack resistance is preferably 10 gf or more or 25 gf or more, particularly preferably from 50 gf to 1,000 gf. With this, cracks are less liable to occur. The “crack resistance” refers to a load at which a rate (=crack occurrence rate) obtained by pressing a Vickers indenter into a surface, and dividing the number of radial cracks occurring from corners of the indentation mark by the total number of the corners of the indentation mark is 50%. The Vickers indenter is pressed thereinto at least 20 times.

The tempered glass of the present invention preferably has the following characteristics before the ion exchange.

A fracture toughness K_{lc} before the ion exchange is preferably 0.7 MPa·m^{0.5} or more, 0.8 MPa·m^{0.5} or more, 1.0 MPa·m^{0.5} or more, or 1.2 MPa·m^{0.5} or more, particularly preferably from 1.5 MPa·m^{0.5} to 3.5 MPa·m^{0.5}. When the fracture toughness K_{lc} is too low, energy required for being shattered into pieces is reduced, and hence the number of broken pieces at the time of breakage is increased. In addition, the CT limit is liable to be reduced.

A Young's modulus before the ion exchange is preferably 70 GPa or more, 72 GPa or more, 73 GPa or more, 74 GPa or more, 75 GPa or more, 76 GPa or more, 77 GPa or more, 78 GPa or more, 79 GPa or more, 80 GPa or more, 83 GPa or more, 85 GPa or more, 87 GPa or more, or 90 GPa or more, particularly preferably from 100 GPa to 150 GPa. When the Young's modulus is low, the tempered glass is liable to be deflected in the case of having a small thickness.

A Vickers hardness before the ion exchange is preferably 500 or more, 550 or more, or 580 or more, particularly preferably from 600 to 2,500. When the Vickers hardness is too low, the glass is liable to be scratched.

The tempered glass of the present invention comprises, in a surface thereof, a compressive stress layer obtained through ion exchange. The compressive stress layer has a compressive stress value of preferably 300 MPa or more, 400 MPa or more, 500 MPa or more, or 600 MPa or more, particularly preferably 700 MPa or more. As the compressive stress value becomes higher, the critical energy release rate Gc is increased more. Meanwhile, when an excessively large compressive stress is formed in the surface, an internal tensile stress is excessively increased. In addition, there is a risk in that dimensional changes before and after the ion exchange treatment are increased. Therefore, the compressive stress layer has a compressive stress value of preferably 1,800 MPa or less or 1,650 MPa or less, particularly preferably 1,500 MPa or less. There is a tendency that the compressive stress value is increased when an ion exchange time is shortened or the temperature of an ion exchange solution is reduced.

The compressive stress layer has a depth of layer of preferably 15 μm or more, 30 μm or more, 35 μm or more, or 40 μm or more, particularly preferably 45 μm or more. As the depth of layer becomes larger, scratch resistance becomes higher and variation in mechanical strength of the tempered glass becomes smaller. Meanwhile, as the depth of layer becomes larger, the internal tensile stress is increased more. In addition, there is a risk in that the dimensional changes before and after the ion exchange treatment are increased. Further, when the depth of layer is excessively large, there is a tendency that the compressive stress value is reduced. Therefore, the depth of layer is preferably 90 μm or less or 80 μm or less, particularly preferably 70 μm or less. There is a tendency that the depth of layer is increased when the ion exchange time is prolonged or the temperature of the ion exchange solution is increased.

An internal tensile stress value is preferably 180 MPa or less, 150 PMa or less, 120 MPa or less, particularly preferably 100 MPa or less. When the internal tensile stress value is too high, the tempered glass is liable to undergo self-destruction owing to a hard scratch. Meanwhile, when the internal tensile stress value is too low, it becomes difficult to ensure the mechanical strength of the tempered glass. The internal tensile stress value is preferably 35 MPa or more, 45 MPa or more, or 55 MPa or more, particularly preferably 70 MPa or more. The internal tensile stress value is a value calculated by the expression: (compressive stress value×depth of layer)/(thickness−2×depth of layer), and may be measured with software FsmV of surface stress meter FSM-6000LE manufactured by Orihara industrial co., ltd.

A CT limit is preferably 65 MPa or more, 70 MPa or more, 80 MPa or more, or 90 MPa or more, particularly preferably from 100 MPa to 300 MPa. In addition, a CT limit converted into a thickness of 0.5 mm is preferably 65 MPa or more, 70 MPa or more, 80 MPa or more, or 90 MPa or more, particularly preferably from 100 MPa to 300 MPa. When the CT limit is too low, it becomes difficult to increase the depth of layer, with the result that it becomes difficult to ensure the mechanical strength of the tempered glass.

The tempered glass of the present invention preferably has a sheet shape, and has a thickness of preferably 2.0 mm or less, 1.5 mm or less, 1.3 mm or less, 1.1 mm or less, or 1.0 mm or less, particularly preferably 0.9 mm or less. As the thickness becomes smaller, the weight of the tempered glass can be reduced more. Meanwhile, when the thickness is too small, it becomes difficult to obtain desired mechanical strength. Therefore, the thickness is preferably 0.3 mm or more, 0.4 mm or more, 0.5 mm or more, or 0.6 mm or more, particularly preferably 0.7 mm or more.

A method of manufacturing the tempered glass of the present invention is, for example, as described below. First, glass raw materials blended so as to give a desired glass composition are loaded into a continuous melting furnace, heated to be melted at from 1,400° C. to 1,700° C., and fined. After that, the molten glass is supplied to a forming apparatus and formed into a sheet shape, followed by cooling, to thereby obtain a glass sheet (crystallizable glass sheet). As a method of cut processing, into predetermined dimensions, the glass having been formed into a sheet shape, a well-known method may be adopted.

As a method of forming the molten glass into a sheet shape, an overflow down-draw method is preferably adopted. The overflow down-draw method is a method by which a high-quality glass sheet can be manufactured in a large amount. The “overflow down-draw method” as used herein refers to a method involving causing molten glass to overflow from both sides of forming body refractory, and subjecting the overflowing molten glasses to down-draw downward while the molten glasses are joined at the lower end of the forming body refractory, to thereby form a sheet shape. In the overflow down-draw method, a surface to serve as the surface of the tempered glass is not brought into contact with the forming body refractory, and is formed into a sheet shape in a state of a free surface. Thus, a tempered glass having satisfactory surface quality can be manufactured inexpensively without polishing.

Various forming methods other than the overflow down-draw method may be adopted. For example, forming methods such as a float method, a down-draw method (such as a slot down-draw method or a re-draw method), a roll out method, and a press method may be adopted.

Next, when the glass sheet is a crystallizable glass sheet, it is preferred to subject the crystallizable glass sheet to heat treatment to obtain a crystallized glass sheet. A heat treatment step preferably comprises a crystal nucleation step of forming a crystal nucleus in a glass matrix, and a crystal growth step of growing the crystal nucleus having been formed. In the crystal nucleation step, a heat treatment temperature is preferably from 450° C. to 700° C., particularly preferably from 480° C. to 650° C., and a heat treatment time is preferably from 10 minutes to 24 hours, particularly preferably from 30 minutes to 12 hours. In addition, in the crystal growth step, a heat treatment temperature is preferably from 780° C. to 920° C., particularly preferably from 820° C. to 880° C., and a heat treatment time is preferably from 10 minutes to 5 hours, particularly preferably from 30 minutes to 3 hours. In addition, a temperature increase rate is preferably from 1° C./min to 30° C./min, particularly preferably from 1° C./min to 10° C./min. When the heat treatment temperatures, the heat treatment times, and the temperature increase rate are outside the above-mentioned ranges, the crystallite size is coarsened, and the crystallinity is reduced.

Subsequently, the glass sheet (crystallized glass sheet) is subjected to ion exchange treatment to form, in the surface, the compressive stress layer obtained through ion exchange. When the ion exchange treatment is performed, the compressive stress layer is formed in the surface, and hence the fracture toughness K_{lc} can be increased. The conditions of the ion exchange treatment are not particularly limited, and optimum conditions may be selected in consideration of the viscosity characteristics of the glass, a thickness, an internal tensile stress, a dimensional change, and the like. In particular, a Na ion in a molten salt of NaNO₃ or in a mixed molten salt of KNO₃ and NaNO₃ is preferably ion exchanged with a Li component in the glass. The ion exchange of a Na ion with a Li component has a higher exchange speed than the ion exchange of a K ion with a Na component, and the ion exchange treatment can be performed efficiently. An ion exchange liquid temperature is preferably from 380° C. to 500° C., and an ion exchange time is preferably from 1 hour to 1,000 hours, from 2 hours to 800 hours, or from 3 hours to 500 hours, particularly preferably from 4 hours to 200 hours.

### EXAMPLES

The present invention is hereinafter described with reference to Examples. The following Examples are merely illustrative. The present invention is by no means limited to the following Examples.

The glass compositions and glass characteristics of Examples (Sample Nos. 1 to 6) of the present invention are shown in Table 1.

TABLE 1

| (mol %) | No. 1 | No. 2 | No. 3 | No. 4 | No. 5 | No. 6 |
|---|---|---|---|---|---|---|
| SiO₂ | 66.9 | 66.9 | 66.9 | 66.9 | 66.9 | 64.9 |
| Al₂O₃ | 3.0 | 3.0 | 3.0 | 3.0 | 3.0 | 4.0 |
| P₂O₅ | 0.7 | 0.7 | 0.7 | 0.7 | 0.7 | 0.7 |
| Li₂O | 21.3 | 21.3 | 21.3 | 21.3 | 21.3 | 21.3 |
| Na₂O | 2.4 | 2.4 | 2.4 | 2.4 | 2.4 | 3.7 |
| K₂O | 1.4 | 1.4 | 1.4 | 1.4 | 1.4 | 0.0 |
| ZrO₂ | 4.2 | 4.2 | 4.2 | 4.2 | 4.2 | 5.2 |
| SnO₂ | 0.0 | 0.0 | 0.0 | 0.0 | 0.0 | 0.1 |
| Sb₂O₃ | 0.1 | 0.1 | 0.1 | 0.1 | 0.1 | 0.0 |
| Temperature increase | 1° C./min | 10° C./min | 10° C./min | 10° C./min | 10° C./min | 10° C./min |
| rate from room | | | | | | |
| temperature to crystal | | | | | | |
| nucleation temperature | | | | | | |
| Crystal nucleation | 500° C., | 500° C., | 615° C., | 615° C., | 615° C., | 500° C., |
| conditions | 30 min | 30 min | 30 min | 30 min | 12 hr | 30 min |
| Temperature increase | 1° C./min | 10° C./min | 10° C./min | 10° C./min | 10° C./min | 10° C./min |
| rate from crystal | | | | | | |
| nucleation temperature | | | | | | |
| to crystal growth | | | | | | |
| temperature | | | | | | |
| Crystal growth | 850° C., | 850° C., | 850° C., | 750° C., | 850° C., | 850° C., |
| conditions | 30 min | 30 min | 30 min | 30 min | 3 hr | 30 min |
| Temperature reduction | 1° C./min | 10° C./min | 10° C./min | 10° C./min | 10° C./min | 10° C./min |
| rate from crystal growth | | | | | | |
| temperature to room | | | | | | |
| temperature | | | | | | |
| Density (g/cm³) | | | | | | |
| Before crystallization | 2.51 | 2.51 | 2.51 | 2.51 | 2.51 | 2.51 |
| After crystallization | 2.55 | 2.53 | 2.53 | 2.53 | 2.55 | 2.56 |
| α (× 10⁻⁷/° C.) | | | | | | |
| Before crystallization | 91 | 91 | 91 | 91 | 91 | 91 |
| After crystallization | 86 | 86 | 86 | 86 | 86 | 89 |
| E (GPa) | | | | | | |
| Before crystallization | 85 | 85 | 85 | 85 | 85 | 89 |
| After crystallization | 100 | 91 | 92 | 91 | 99 | 93 |
| Gc (J/m²) | | | | | | |
| Before crystallization | 8.7 | 8.7 | 8.7 | 8.7 | 8.7 | Not |
| | | | | | | measured |
| After crystallization | 32.4 | 20.3 | 21.3 | 16.3 | 25.9 | 17.8 |
| Main crystal | Li₂Si₂O₅ | LiSi₂O₃ | LiSi₂O₃ | LiSi₂O₃ | Li₂Si₂O₅ | LiSi₂O₃ |
| Crystallinity (%) | 36 | Not | Not | Not | Not | Not |
| | | measured | measured | measured | measured | measured |
| Crystallite size (nm) | 60 | Not | Not | Not | Not | Not |
| | | measured | measured | measured | measured | measured |
| Optical elastic | 25.1 | Not | Not | Not | 25.1 | Not |
| constant (nm/cm/MPa) | | measured | measured | measured | | measured |
| Refractive index nd | 1.55 | Not | Not | Not | 1.55 | Not |
| | | measured | measured | measured | | measured |
| Compressive stress | 423 | Not | Not | Not | 445 | Not |
| value (MPa) | | measured | measured | measured | | measured |
| Depth of layer (μm) | 50 | Not | Not | Not | 50 | Not |
| | | measured | measured | measured | | measured |
| CT limit (MPa) at a | More than | More than | More than | More than | More than | More than |
| thickness of 0.5 mm | 100 | 100 | 100 | 100 | 100 | 100 |

Samples in the table were each produced as described below. First, glass raw materials were blended so as to give a glass composition shown in the table, and were melted at 1,550° C. for 8 hours in a platinum pot. Subsequently, the obtained molten glass was poured out on a carbon sheet and formed into a flat sheet shape, followed by being annealed in an annealing furnace to obtain a crystallizable glass sheet. The surface of the obtained crystallizable glass sheet (glass sheet to be tempered) was optically polished so as to give a thickness of 0.5 mm, and then the crystallizable glass sheet was evaluated for various characteristics.

Subsequently, through use of an electric furnace, the obtained crystallizable glass sheet was increased in temperature from normal temperature at a temperature increase rate shown in Table 1, and then a crystal nucleus was formed therein under crystal nucleation conditions shown in Table 1. Further, a crystal was grown in a glass matrix at a temperature increase/temperature reduction rate and under crystal growth conditions shown in Table 1. After that, the glass sheet was cooled to normal temperature at a temperature reduction rate shown in Table 1 to obtain a crystallized glass sheet. The obtained crystallized glass sheet was evaluated for various characteristics.

The density is a value measured by a well-known Archimedes method.

The thermal expansion coefficient α within the temperature range of from 30° C. to 380° C. is a value measured with a dilatometer.

The Young's modulus E is a value measured by a well-known resonance method.

The critical energy release rate Gc is a value calculated by the equation: Gc=K_{lc}²/E. The fracture toughness K_{lc} is measured by a SEPB method based on “Testing methods for fracture toughness of fine ceramics at room temperature” of JIS R1607 (an average value over five times of measurement).

The main crystal is evaluated by powder X-ray diffraction using an X-ray diffractometer (RINT-2100 manufactured by Rigaku Corporation). The measurement range was set to 2θ=10° to 60°.

The crystallinity is evaluated by powder X-ray diffraction using an X-ray diffractometer (RINT-2100 manufactured by Rigaku Corporation). Specifically, the crystallinity refers to a value determined as follows: a halo area corresponding to a mass of an amorphous component and a peak area corresponding to a mass of a crystalline component are calculated, and then the crystallinity is determined by the expression: [peak area]×100/[peak area+halo area] (%). The measurement range was set to 2θ=10° to 60°.

The crystallite size is calculated by a Scherrer equation from analysis results of powder X-ray diffraction.

The optical elastic constant is a value calculated with an optical elastic constant measurement device manufactured by Uniopt Co., Ltd.

The refractive index nd is measured by a V-block method. The nd is a refractive index at the d line.

Next, the crystallized glass sheets were each subjected to ion exchange treatment by being immersed in KNO₃ at 450° C. for 168 hours, to thereby form a compressive stress layer in a surface thereof. Thus, tempered glasses (Sample Nos. 1 to 6) were obtained.

The compressive stress value and the depth of layer are calculated with a surface stress meter (surface stress meter FSM-6000LE manufactured by Orihara industrial co., ltd.). At the time of the calculation, the optical elastic constant and the refractive index nd were used.

In addition, the crystallized glass sheets were each subjected to ion exchange treatment under various conditions. Thus, tempered glasses in different stress states were produced. Subsequently, an indenter test using a diamond tip was performed on a surface plate. When a delayed fracture occurred, data on the number of broken pieces at a CTcv value (two points) at which the number of broken pieces exceeded 100 pieces/in², and data on the number of broken pieces at a CTcv value (two points) at which the number of broken pieces was less than 100 pieces/in² were collected. The data on the number of broken pieces at each point was an average value over three times of measurement. Further, an exponential approximation curve was drawn from the data on the number of broken pieces at the CTcv values at the total four points, and then the CT limit was calculated from the approximation curve as a CTcv value at which the number of broken pieces was 100. The CTcv value is obtained from a CTcv value of software FsmV of surface stress meter FSM-6000LE manufactured by Orihara industrial co., ltd. on the basis of the optical elastic constant and the refractive index nd in Table 1.

As apparent from Table 1, Sample Nos. 1 to 6 each had a high critical energy release rate Gc before ion exchange, and hence had a high CT limit. Therefore, it is conceivable that Sample Nos. 1 to 6 are each less liable to be shattered into pieces at the time of breakage even when having a large depth of layer. Just for reference, an aluminosilicate glass comprising as a glass composition, in terms of mol o, 66.4% of SiO₂, 11.4% of Al₂O₃, 4.7% of MgO, 0.5% of B₂O₃, 0.1% of CaO, 0.2% of SnO₂, 0.01% of Li₂O, 15.3% of Na₂O, and 1.4% of K₂O had a critical energy release rate Gc of 6.9 J/m² before ion exchange, and hence had a CT limit of 65 MPa measured by the above-mentioned method.

While Sample Nos. 7 to 11 described below are not examined at this moment, it is predicted that also Sample Nos. 7 to 11 obtain similar effects as described above when subjected to a similar experiment as described above.

TABLE 2

| (mol %) | No. 7 | No. 8 | No. 9 | No. 10 | No. 11 |
|---|---|---|---|---|---|
| SiO₂ | 71.9 | 66.9 | 76.9 | 66.9 | 71.9 |
| Al₂O₃ | 3.0 | 8.0 | 3.0 | 13.0 | 8.0 |
| P₂O₃ | 0.7 | 0.7 | 0.7 | 0.7 | 0.7 |
| Li₂O | 16.3 | 16.3 | 11.3 | 11.3 | 11.3 |
| Na₂O | 2.4 | 2.4 | 2.4 | 2.4 | 2.4 |
| K₂O | 1.4 | 1.4 | 1.4 | 1.4 | 1.4 |
| ZrO₂ | 4.2 | 4.2 | 4.2 | 4.2 | 4.2 |
| SnO₂ | 0.1 | 0.1 | 0.1 | 0.1 | 0.1 |
| Sb₂O₃ | 0.0 | 0.0 | 0.0 | 0.0 | 0.0 |

In each of Examples described above, the crystallizable glass sheet was subjected to heat treatment to obtain the crystallized glass sheet, and then the crystallized glass sheet was subjected to ion exchange treatment to produce the tempered glass. However, the tempered glass may be produced by directly subjecting the crystallizable glass sheet to ion exchange treatment.

The glass compositions of Examples (Sample Nos. 12 to 59) of the present invention are shown in Tables 3 to 9. For each of Sample Nos. 12 to 59, a glass sheet obtained by the above-mentioned method may be subjected to heat treatment to obtain a crystallized glass sheet, and then the crystallized glass sheet may be subjected to ion exchange treatment to produce a tempered glass. Alternatively, the glass sheet obtained by the above-mentioned method may be directly subjected to ion exchange treatment to produce the tempered glass.

TABLE 3

| (mol %) | No. 12 | No. 13 | No. 14 | No. 15 | No. 16 | No. 17 | No. 18 | No. 19 | No. 20 | No. 21 |
|---|---|---|---|---|---|---|---|---|---|---|
| SiO₂ | 62.9 | 62.9 | 62.9 | 63.0 | 63.4 | 63.0 | 63.0 | 65.7 | 64.1 | 64.1 |
| Al₂O₃ | 18.8 | 17.8 | 16.8 | 18.8 | 18.8 | 18.8 | 18.1 | 17.6 | 18.1 | 18.1 |
| P₂O₅ | 0.5 | 0.5 | 0.5 | 0.4 | 0.0 | 1.4 | 1.4 | 0.4 | 1.4 | 3.1 |
| Li₂O | 7.3 | 7.3 | 8.3 | 7.3 | 7.3 | 7.3 | 8.7 | 6.1 | 6.3 | 6.3 |
| Na₂O | 9.1 | 10.1 | 10.1 | 8.6 | 8.6 | 8.6 | 7.9 | 8.0 | 8.2 | 8.2 |
| K₂O | 1.3 | 1.3 | 1.3 | 0.8 | 0.8 | 0.8 | 0.8 | 2.2 | 1.7 | 0.0 |
| ZrO₂ | 0.0 | 0.0 | 0.0 | 0.0 | 0.0 | 0.0 | 0.0 | 0.0 | 0.0 | 0.0 |
| SnO₂ | 0.0 | 0.0 | 0.0 | 0.0 | 0.0 | 0.0 | 0.0 | 0.0 | 0.0 | 0.0 |
| Sb₂O₃ | 0.0 | 0.0 | 0.0 | 0.0 | 0.0 | 0.0 | 0.0 | 0.0 | 0.0 | 0.0 |
| B₂O₃ | 0.1 | 0.1 | 0.1 | 0.1 | 0.1 | 0.1 | 0.1 | 0.1 | 0.1 | 0.1 |
| MgO | 0.0 | 0.0 | 0.0 | 1.0 | 1.0 | 0.0 | 0.0 | 0.0 | 0.0 | 0.0 |
| CaO | 0.0 | 0.0 | 0.0 | 0.0 | 0.0 | 0.0 | 0.0 | 0.0 | 0.0 | 0.0 |
| Y₂O₃ | 0.0 | 0.0 | 0.0 | 0.0 | 0.0 | 0.0 | 0.0 | 0.0 | 0.0 | 0.0 |
| TiO₂ | 0.0 | 0.0 | 0.0 | 0.0 | 0.0 | 0.0 | 0.0 | 0.0 | 0.0 | 0.0 |
| HfO₂ | 0.0 | 0.0 | 0.0 | 0.0 | 0.0 | 0.0 | 0.0 | 0.0 | 0.0 | 0.0 |
| SO₃ | 0.0 | 0.0 | 0.0 | 0.0 | 0.0 | 0.0 | 0.0 | 0.0 | 0.0 | 0.0 |
| Cl | 0.0 | 0.0 | 0.0 | 0.0 | 0.0 | 0.0 | 0.0 | 0.0 | 0.0 | 0.0 |

TABLE 4

| (mol %) | No. 22 | No. 23 | No. 24 | No. 25 | No. 26 | No. 27 | No. 28 | No. 29 | No. 30 | No. 31 |
|---|---|---|---|---|---|---|---|---|---|---|
| SiO₂ | 62.6 | 64.5 | 64.5 | 64.5 | 64.5 | 64.5 | 64.5 | 64.5 | 64.5 | 64.5 |
| Al₂O₃ | 18.1 | 18.5 | 18.5 | 18.5 | 18.5 | 18.5 | 18.5 | 18.5 | 18.5 | 18.5 |
| P₂O₅ | 3.1 | 4.0 | 4.0 | 4.0 | 3.0 | 3.0 | 3.0 | 2.0 | 2.0 | 2.0 |
| Li₂O | 6.3 | 6.0 | 7.0 | 8.0 | 6.0 | 7.0 | 8.0 | 6.0 | 7.0 | 8.0 |
| Na₂O | 8.9 | 6.0 | 5.0 | 4.0 | 7.0 | 6.0 | 5.0 | 8.0 | 7.0 | 6.0 |
| K₂O | 0.8 | 0.8 | 0.8 | 0.8 | 0.8 | 0.8 | 0.8 | 0.8 | 0.8 | 0.8 |
| ZrO₂ | 0.0 | 0.0 | 0.0 | 0.0 | 0.0 | 0.0 | 0.0 | 0.0 | 0.0 | 0.0 |
| SnO₂ | 0.0 | 0.0 | 0.0 | 0.0 | 0.0 | 0.0 | 0.0 | 0.0 | 0.0 | 0.0 |
| Sb₂O₃ | 0.0 | 0.0 | 0.0 | 0.0 | 0.0 | 0.0 | 0.0 | 0.0 | 0.0 | 0.0 |
| B₂O₃ | 0.1 | 0.1 | 0.1 | 0.1 | 0.1 | 0.1 | 0.1 | 0.1 | 0.1 | 0.1 |
| MgO | 0.0 | 0.1 | 0.1 | 0.1 | 0.1 | 0.1 | 0.1 | 0.1 | 0.1 | 0.1 |
| CaO | 0.0 | 0.0 | 0.0 | 0.0 | 0.0 | 0.0 | 0.0 | 0.0 | 0.0 | 0.0 |
| Y₂O₃ | 0.0 | 0.0 | 0.0 | 0.0 | 0.0 | 0.0 | 0.0 | 0.0 | 0.0 | 0.0 |
| TiO₂ | 0.0 | 0.0 | 0.0 | 0.0 | 0.0 | 0.0 | 0.0 | 0.0 | 0.0 | 0.0 |
| HfO₂ | 0.0 | 0.0 | 0.0 | 0.0 | 0.0 | 0.0 | 0.0 | 0.0 | 0.0 | 0.0 |
| SO₃ | 0.0 | 0.0 | 0.0 | 0.0 | 0.0 | 0.0 | 0.0 | 0.0 | 0.0 | 0.0 |
| Cl | 0.0 | 0.0 | 0.0 | 0.0 | 0.0 | 0.0 | 0.0 | 0.0 | 0.0 | 0.0 |

TABLE 5

| (mol %) | No. 32 | No. 33 | No. 34 | No. 35 | No. 36 | No. 37 | No. 38 | No. 39 | No. 40 | No. 41 |
|---|---|---|---|---|---|---|---|---|---|---|
| SiO₂ | 64.5 | 64.5 | 64.5 | 64.5 | 64.5 | 64.5 | 64.5 | 64.5 | 64.5 | 61.3 |
| Al₂O₃ | 18.5 | 18.5 | 18.5 | 18.5 | 18.5 | 18.5 | 18.5 | 18.5 | 18.5 | 15.4 |
| P₂O₅ | 4.0 | 4.0 | 4.0 | 3.0 | 3.0 | 3.0 | 2.0 | 2.0 | 2.0 | 3.5 |
| Li₂O | 6.4 | 7.4 | 8.4 | 6.4 | 7.4 | 8.4 | 6.4 | 7.4 | 8.4 | 7.8 |
| Na₂O | 6.4 | 5.4 | 4.4 | 7.4 | 6.4 | 5.4 | 8.4 | 7.4 | 6.4 | 7.0 |
| K₂O | 0.0 | 0.0 | 0.0 | 0.0 | 0.0 | 0.0 | 0.0 | 0.0 | 0.0 | 2.5 |
| ZrO₂ | 0.0 | 0.0 | 0.0 | 0.0 | 0.0 | 0.0 | 0.0 | 0.0 | 0.0 | 0.0 |
| SnO₂ | 0.0 | 0.0 | 0.0 | 0.0 | 0.0 | 0.0 | 0.0 | 0.0 | 0.0 | 0.0 |
| Sb₂O₃ | 0.0 | 0.0 | 0.0 | 0.0 | 0.0 | 0.0 | 0.0 | 0.0 | 0.0 | 0.0 |
| B₂O₃ | 0.1 | 0.1 | 0.1 | 0.1 | 0.1 | 0.1 | 0.1 | 0.1 | 0.1 | 0.1 |
| MgO | 0.1 | 0.1 | 0.1 | 0.1 | 0.1 | 0.1 | 0.1 | 0.1 | 0.1 | 2.4 |
| CaO | 0.0 | 0.0 | 0.0 | 0.0 | 0.0 | 0.0 | 0.0 | 0.0 | 0.0 | 0.0 |
| Y₂O₃ | 0.0 | 0.0 | 0.0 | 0.0 | 0.0 | 0.0 | 0.0 | 0.0 | 0.0 | 0.0 |
| TiO₂ | 0.0 | 0.0 | 0.0 | 0.0 | 0.0 | 0.0 | 0.0 | 0.0 | 0.0 | 0.0 |
| HfO₂ | 0.0 | 0.0 | 0.0 | 0.0 | 0.0 | 0.0 | 0.0 | 0.0 | 0.0 | 0.0 |
| SO₃ | 0.0 | 0.0 | 0.0 | 0.0 | 0.0 | 0.0 | 0.0 | 0.0 | 0.0 | 0.0 |
| Cl | 0.0 | 0.0 | 0.0 | 0.0 | 0.0 | 0.0 | 0.0 | 0.0 | 0.0 | 0.0 |

TABLE 6

| (mol %) | No. 42 | No. 43 | No. 44 | No. 45 | No. 46 | No. 47 | No. 48 | No. 49 | No. 50 | No. 51 |
|---|---|---|---|---|---|---|---|---|---|---|
| SiO₂ | 61.0 | 60.2 | 59.8 | 59.8 | 60.5 | 61.0 | 60.5 | 61.0 | 60.5 | 58.5 |
| Al₂O₃ | 15.0 | 15.4 | 16.5 | 15.4 | 15.0 | 15.0 | 15.0 | 15.0 | 15.0 | 16.2 |
| P₂O₅ | 4.5 | 4.5 | 2.8 | 4.0 | 5.0 | 4.5 | 5.0 | 4.5 | 5.0 | 4.5 |
| Li₂O | 8.0 | 8.0 | 7.8 | 7.8 | 8.0 | 9.0 | 9.0 | 7.0 | 7.0 | 9.3 |
| Na₂O | 7.8 | 7.8 | 7.0 | 7.0 | 7.8 | 6.8 | 6.8 | 8.8 | 8.8 | 6.8 |
| K₂O | 1.5 | 1.5 | 2.5 | 2.5 | 1.5 | 1.5 | 1.5 | 1.5 | 1.5 | 0.8 |
| ZrO₂ | 0.0 | 0.0 | 0.0 | 0.0 | 0.0 | 0.0 | 0.0 | 0.0 | 0.0 | 0.0 |
| SnO₂ | 0.0 | 0.0 | 0.0 | 0.0 | 0.0 | 0.0 | 0.0 | 0.0 | 0.0 | 0.0 |
| Sb₂O₃ | 0.0 | 0.0 | 0.0 | 0.0 | 0.0 | 0.0 | 0.0 | 0.0 | 0.0 | 0.0 |
| B₂O₃ | 0.1 | 0.1 | 0.1 | 0.1 | 0.1 | 0.1 | 0.1 | 0.1 | 0.1 | 0.1 |
| MgO | 2.1 | 2.5 | 3.5 | 2.4 | 2.1 | 2.1 | 2.1 | 2.1 | 2.1 | 4.0 |
| CaO | 0.0 | 0.0 | 0.0 | 0.0 | 0.0 | 0.0 | 0.0 | 0.0 | 0.0 | 0.0 |
| Y₂O₃ | 0.0 | 0.0 | 0.0 | 0.0 | 0.0 | 0.0 | 0.0 | 0.0 | 0.0 | 0.0 |
| TiO₂ | 0.0 | 0.0 | 0.0 | 0.0 | 0.0 | 0.0 | 0.0 | 0.0 | 0.0 | 0.0 |
| HfO₂ | 0.0 | 0.0 | 0.0 | 0.0 | 0.0 | 0.0 | 0.0 | 0.0 | 0.0 | 0.0 |
| SO₃ | 0.0 | 0.0 | 0.0 | 0.0 | 0.0 | 0.0 | 0.0 | 0.0 | 0.0 | 0.0 |
| Cl | 0.0 | 0.0 | 0.0 | 0.0 | 0.0 | 0.0 | 0.0 | 0.0 | 0.0 | 0.0 |

TABLE 7

| (mol %) | No. 52 | No. 53 | No. 54 | No. 55 | No. 56 | No. 57 | No. 58 | No. 59 |
|---|---|---|---|---|---|---|---|---|
| SiO₂ | 61.3 | 68.2 | 68.2 | 61.3 | 60.4 | 68.2 | 70.2 | 66.2 |
| Al₂O₃ | 15.4 | 9.5 | 9.5 | 15.4 | 16.2 | 9.5 | 9.5 | 11.3 |
| P₂O₅ | 3.2 | 0.0 | 0.0 | 3.5 | 4.5 | 0.0 | 0.0 | 0.0 |
| Li₂O | 8.6 | 9.0 | 8.0 | 7.8 | 9.3 | 9.0 | 9.0 | 10.3 |
| Na₂O | 6.5 | 8.2 | 8.2 | 7.0 | 6.8 | 6.2 | 6.2 | 5.5 |
| K₂O | 2.5 | 3.0 | 3.0 | 2.5 | 0.8 | 3.0 | 3.0 | 1.4 |
| ZrO₂ | 0.0 | 0.0 | 0.0 | 0.0 | 0.0 | 0.0 | 0.0 | 1.3 |
| SnO₂ | 0.0 | 0.0 | 0.0 | 0.0 | 0.0 | 0.0 | 0.0 | 0.0 |
| Sb₂O₃ | 0.0 | 0.0 | 0.0 | 0.0 | 0.0 | 0.0 | 0.0 | 0.0 |
| B₂O₃ | 0.1 | 0.1 | 0.1 | 0.1 | 0.1 | 0.1 | 0.1 | 0.0 |
| MgO | 2.4 | 2.0 | 3.0 | 2.4 | 2.1 | 4.0 | 2.0 | 3.1 |
| CaO | 0.0 | 0.0 | 0.0 | 0.0 | 0.0 | 0.0 | 0.0 | 0.2 |
| Y₂O₃ | 0.0 | 0.0 | 0.0 | 0.0 | 0.0 | 0.0 | 0.0 | 0.5 |
| TiO₂ | 0.0 | 0.0 | 0.0 | 0.0 | 0.0 | 0.0 | 0.0 | 0.1 |
| HfO₂ | 0.0 | 0.0 | 0.0 | 0.0 | 0.0 | 0.0 | 0.0 | 0.0 |
| SO₃ | 0.0 | 0.0 | 0.0 | 0.0 | 0.0 | 0.0 | 0.0 | 0.0 |
| Cl | 0.0 | 0.0 | 0.0 | 0.0 | 0.0 | 0.0 | 0.0 | 0.0 |

### INDUSTRIAL APPLICABILITY

While the tempered glass of the present invention is suitable as a cover glass for a touch panel display, the tempered glass of the present invention is also suitable as an in-vehicle glass or a bearing ball other than the above-mentioned application.

1. A tempered glass, comprising, in a surface thereof, a compressive stress layer obtained through ion exchange,
wherein the tempered glass comprises as a composition, in terms of mol %, 50% to 80% of SiO₂, 0% to 20% of Al₂O₃, 0% to 10% of B₂O₃, 0% to 15% of P₂O₅, 0% to 35% of Li₂O, 0% to 12% of Na₂O, and 0% to 7% of K₂O.

2. The tempered glass according to claim 1, wherein the tempered glass has a critical energy release rate Gc of 8.0 J/m² or more before the ion exchange.

3. The tempered glass according to claim 1, wherein the tempered glass has a Young's modulus of 80 GPa or more.

4. The tempered glass according to claim 1, wherein the tempered glass is formed of crystallized glass.

5. The tempered glass according to claim 4, wherein the crystallized glass has a crystallinity of 5% or more.

6. The tempered glass according to claim 4, wherein the crystallized glass has a crystallite size of 500 nm or less.

7. The tempered glass according to claim 4, wherein the crystallized glass comprises lithium disilicate as a main crystal.

8. The tempered glass according to claim 1, wherein the tempered glass has a sheet shape and has a thickness of from 0.1 mm to 2.0 mm.

9. The tempered glass according to claim 1, wherein the compressive stress layer has a compressive stress value of 300 MPa or more and a depth of layer of 15 μm or more.

10. The tempered glass according to claim 1, wherein the tempered glass has a CT limit of more than 65 MPa.

11. The tempered glass according to claim 1, wherein the tempered glass is used as a cover glass for a touch panel display.

12. A glass to be tempered for producing a tempered glass comprising, in a surface thereof, a compressive stress layer obtained through ion exchange,
the glass to be tempered comprising as a composition, in terms of mol %, 50% to 80% of SiO₂, 0% to 20% of Al₂O₃, 0% to 10% of B₂O₃, 0% to 15% of P₂O₅, 0% to 35% of Li₂O, 0% to 12% of Na₂O, and 0% to 7% of K₂O.

13. The glass to be tempered according to claim 12, wherein the glass to be tempered has a critical energy release rate Gc of 8.0 J/m² or more.

14. The glass to be tempered according to claim 12, wherein the glass to be tempered is formed of crystallized glass.
